(19) United States
(12) Patent Application Publication
(10) Pub. No.: US 2015/0149318 A1
(43) Pub. Date: May 28, 2015

(54) System and Method For Determining and Displaying the Metabolic Energy of Skin Cells

(71) Applicant: The Procter & Gamble Company, Cincinnati, OH (US)

(72) Inventors: David Boon Kheng KHOO, Singapore (SG); Kukizo MIYAMOTO, Kobe (JP); John Erich OBLONG, Cincinnati, OH (US); Mary Begovic JOHNSON, Cincinnati, OH (US); Phillip John MARCHANT, Geneva (SZ); Kaisy Mae Cortez O'REILLY, Singapore (SG); Carole ENTWISTLE, Geneva (SZ)

(73) Assignee: The Procter & Gamble Company, Cincinnati, OH (US)

(21) Appl. No.: 14/088,217

(22) Filed: Nov. 22, 2013

(51) Int. Cl. G06Q 30/06

(52) U.S. Cl. CPC G06Q 30/0631
USPC 705/26.7

(57) ABSTRACT

The present invention is related to a computer-based system and method for determining and displaying the metabolic energy of skin cells of an individual, based on a set of biological data collected from the individual, including but not limited to: skin wrinkling, skin texture, skin pigmentation, skin hydration, age, UV exposure, and/or health habits. Particularly, the present invention is useful for counseling consumers of cosmetic products on sales counters regarding the metabolic energy of their skin and making corresponding recommendations for appropriate cosmetic products that will improve their skin metabolic energy.

### FIELD OF THE INVENTION

This invention relates to a computer-based system and method for determining and displaying the metabolic energy of skin cells of an individual, based on a set of biological data collected from the individual, which include but are not limited to: skin wrinkling, skin texture, skin pigmentation, skin hydration, age, UV exposure, and/or health habits. This invention also relates to a system and method for making recommendations of skin care products to consumers based on their corresponding skin energy score so computed.

### BACKGROUND OF THE INVENTION

Recent developments of various state-of-the-art skin imaging technologies have made it easier and faster for medical professionals and researchers to visualize skin cells and assess their physiological and metabolic conditions. For example, two-dimensional digital dermatoscopic images can be obtained by CCD cameras and image processing software. Ultra-sound and OCT systems enable capture of three-dimensional images from the epidermis and dermis layers of the skin. Multi-photon tomography is a novel multi-dimensional imaging technology that employs fluorescence and second harmonic generation to achieve sub-cellular resolution without having to stain the tissue. It takes advantage of certain endogenous fluorophores, such as NADP(H), flavines, elastin, collagen, and melanin, and relies on the fluorescence thereby to achieve function imaging of deep-tissue cells and their cellular compartments (see, Karsten König, Clinical Multiphoton Tomography, JOURNAL OF BIOPHOTONICS, NO. 1, pp. 13-23 (2008)). Specifically, these endogenous fluorophores can be readily excited using distinct illumination wavelengths for complementary imaging to provide information on the mitochondrial functions, cellular energy metabolism and respiration, oxidative stress, and apoptosis (see, Ahmed A Heikal, Intracellular Coenzymes as Natural Biomarkers for Metabolic Activities and Mitochondrial Anomalies, BIOMARK MED. 4(2), pp. 241-263 (2010 April)).

Despite the availability of such in-depth visualization methods and tools, it is still costly and time-consuming to evaluate and assess the skin condition of an individual on the sub-cellular level, especially the metabolic energy of the skin cells of such individual. Particularly, these methods and tools are limited to usage in the research laboratories, and they are not suitable for real-time, over-the-counter evaluation and assessment of the skin condition of a consumer.

Therefore, there is still a need for an improved system and method for faster and more cost-effective skin evaluation and assessment, which can be used to carry out a real-time, over-the-counter evaluation and assessment of the skin condition of individual consumers.

More specifically, there is a need for a market-friendly system and method for determining and displaying the metabolic energy of the skin cells of individual consumers on the sales counters of skincare or cosmetic products, so as to enable customized recommendations for skincare or cosmetic products based on the determined metabolic energy of the skin cells of the individual consumers.

### SUMMARY OF THE INVENTION

The present invention provides a computer-based system and method for faster and more cost-effective evaluation and assessment of the metabolic energy of skin cells of a particular individual.

In a particular embodiment, the present invention is related to a system for determining and displaying the metabolic energy of skin cells, which includes:
(a) one or more portable devices for collecting a set of biological data from an individual, wherein this set of biological data is selected from the group consisting of skin wrinkling, skin texture, skin pigmentation, skin hydration, age, UV exposure, health habits, and combinations thereof in relation to the individual;
(b) one or more computational devices for computing a skin energy score indicative of the metabolic energy of the skin cells of the individual, wherein the skin energy score is computed as a function of said one or more biological data, wherein such function is established by:
   (1) collecting the one or more biological data and skin cell samples from a sample population of individuals;
   (2) measuring the metabolic energy of the collected skin cell samples by detecting the concentration and/or distribution of one or more biomarkers; and
   (3) correlating the measured metabolic energy of the skin cell samples with such one or more biological data collected from the sample population of individuals by a statistical method; and
(c) one or more output display devices for displaying the computed skin energy score on the in-store sales counters.

In another embodiment, the present invention is related to method for determining and displaying the metabolic energy of skin cells, which contains the steps of:
(a) collecting a set of biological data from an individual, wherein the set of biological data is selected from the group consisting of skin wrinkling, skin texture, skin pigmentation, skin hydration, age, UV exposure, health habits, and combinations thereof in relation to the individual;
(b) computing a skin energy score indicative of the metabolic energy of the skin cells of the individual, wherein such skin energy score is computed as a function of said one or more biological data, wherein such function is established by:
   (1) collecting the one or more biological data and skin cell samples from a sample population of individuals;
   (2) measuring the metabolic energy of the collected skin cell samples by detecting the concentration and/or distribution of one or more biomarkers; and
   (3) correlating the measured metabolic energy of the skin cell samples with such one or more biological data collected from the sample population of individuals by a statistical method; and
(c) displaying the computed skin energy score on in-store sales counters.

The above-described system and method may further involve devices or steps for making recommendations of cosmetic or skin care products based on the skin energy score so calculated.

### BRIEF DESCRIPTION OF THE DRAWINGS

FIG. 1A is a two-photon NADP(H) tomographic image of inner forearm skin at 24 μm depth.

FIG. 1B is a flow chart illustrating the NADP(H)-based multi-photon imaging of skin cell activation and rejuvenation.

FIG. 2A is a two-photon NADP(H) tomographic image of skin cell samples from a 22-year-old female individual.

FIG. 2B is a two-photon NADP(H) tomographic image of skin cell samples from a 60-year-old female individual.

FIG. 3 is a graph showing two columns, one representing the average granular cell NADP(H) level in facial skin samples collected from individuals in their 20's, and the other representing the average granular cell NADP(H) level in facial skin samples collected from individuals in their 60's.

FIG. 4 is a graph plotting the granular cell NADP(H) levels in facial skin samples collected from 80 healthy Japanese female individuals against their ages, with a line indicative of the correlation between the granular cell NADP(H) levels and the individual's age.

FIGS. 5A-13B are exemplary computer screenshots showing the steps of collecting biological data from an individual and calculating/displaying a skin energy score computed based on such biological data indicative of the metabolic energy of the skin cells of such individual.

### DETAILED DESCRIPTION OF THE INVENTION

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

The present invention provides a computer-based system for determining and displaying the metabolic energy of skin cells of individuals in a fast and cost-effective manner, so as to enable use of such system over in-store sales counters to support real-time skin energy diagnosis of customers, as well as to support the marketing effort for corresponding cosmetic and skincare products that may help to energize and rejuvenate the skin of such customers.

In order to do so, the present invention proposes to calculate a skin energy score that is indicative of the metabolic energy of the skin cells of an individual. The skin energy score is calculated by a function that factors in various biological data collected from the individual customer, such as, for example, skin wrinkling, skin texture, skin pigmentation, skin hydration, age, UV exposure, and/or health habits. The skin energy score-calculating function is in turn established by empirical studies that correlate one or more or all of the above-listed biological data collected from a sample population of individuals with the metabolic energy level measured in the skin cell samples collected from such individuals. Because actual measurement of the metabolic energy level in the skin cells of the individual customer is so costly and time-consuming as to prohibit the use thereof in real market places, the present invention utilizes an empirically derived function to calculate the skin energy score, thereby effectively eliminating the need for actual skin energy measurement.

### Skin Metabolic Energy Measurement

The skin metabolic energy can be measured by detecting the concentration and/or distribution of one or more biomarkers that is known to be involved in one of the cellular metabolic pathways of the human skin cells. Such biomarkers include, but are not limited to, NADP(H), flavines, elastin, collagen, melanin, protoprophyrin IX monomers, advanced glycation end products (AGEs), IL-1α, ATP, and the like.

The concentration and/or distribution of such biomarkers can be readily detected by various methods and techniques known in the art, which include both conventional biochemical assays such as capillary electrophoresis, cycling assays, high performance liquid chromatography analyses, and spectrophotometric assays (e.g., luciferase-based liquid scintillation spectrometric assays), and recently developed methods such as confocal microscopy, optical coherence tomography, one/two/multi-photon tomography, and the like.

In a preferred, but not necessary, embodiment of the present invention, a NADP(H)-based two-photon tomography method is used to measure the skin metabolic energy level. The mitochondrial co-enzyme NADP(H) is an endogenous fluorophore present in mitochondria, and it plays a pivotal role in cell energy metabolism, oxidative stress, and apoptosis. Autofluorescence of NADP(H) can be excited using distinct wavelengths for complementary imaging methods and is sensitive to protein binding and local environment. Therefore, NADP(H) is a particularly preferred biomarker for skin metabolic energy level. In-vivo two-photon tomography developed by JenLab GmbH (Germany) is a new in-depth skin visualization technique that is particularly useful for detecting and measuring the concentration and distribution of NADP(H) and/or keratohyalin at high resolution, thereby enabling a detailed precise look into the skin (see, Karsten Konig, Clinical Multiphoton Tomography, JOURNAL OF BIOPHOTONICS, NO. 1, pp. 13-23 (2008)).

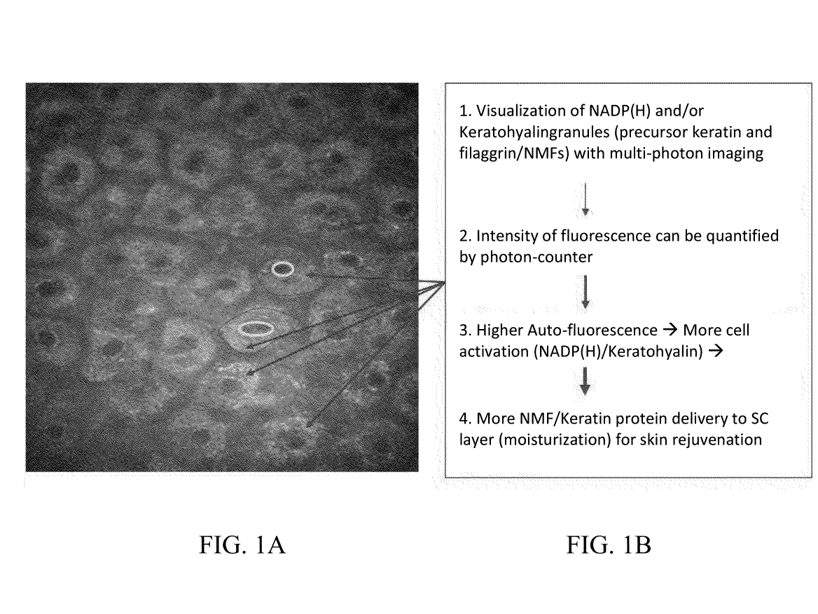

FIG. 1A shows a two-photon tomographic image of inner forearm skin cells taken at a 24 μm depth (i.e., granular layer cells) by a MPTFlex™ flexible in-vivo multiphoton laser equipment (commercially available from JenLab GmbH, Germany) at a femotsecond laser wavelength (WL) of 760 nm, a scan range of 350 μm (horizontal) and 200 μm (vertical), and a spatial resolution of less than 2 μm (vertical). FIG. 1B is a flow chart illustrating step by step how the NADP(H)-based multi-photon images of skin cells can be used for assessing skin cell activation and rejuvenation.

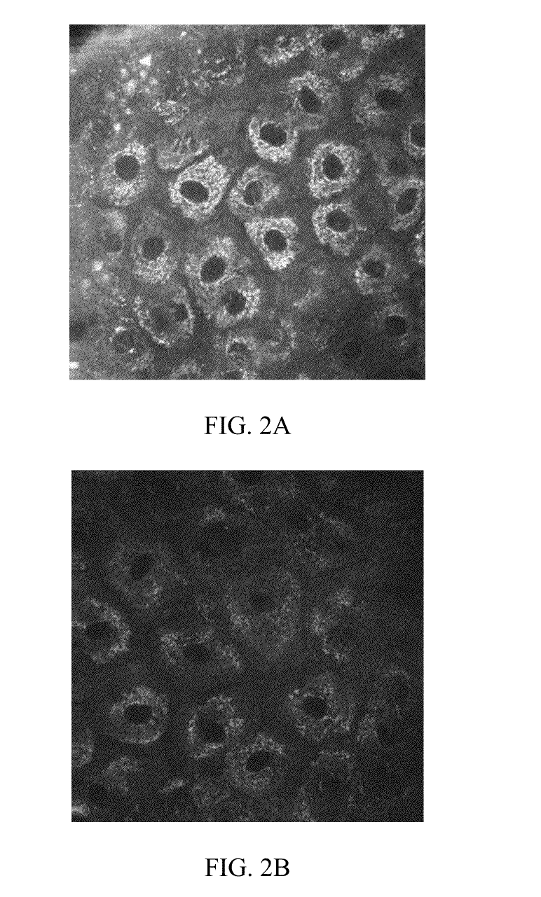

FIG. 2A is a two-photon NADP(H) tomographic image of skin cell samples from a 22-year-old female individual. FIG. 2B is a two-photon NADP(H) tomographic image of skin cell samples from a 60-year-old female individual. The visual differences between these two images taken from skin cell samples of female individuals of different ages are self-evident.

### Design of Empirical Studies

In order to explore the correlation between the metabolic energy levels of skin cells from an individual and various biological data that may affect the skin metabolic energy, such as, for example, skin wrinkling, skin texture, skin pigmentation, skin hydration, age, UV exposure, health habits, and the like, empirical studies can be designed to: (1) collect skin cell samples from a sample population of individuals; (2) measure the metabolic energy levels in such skin cell samples, e.g., by using the two-photon NADP(H) tomography or some other suitable methodologies; (3) measure the skin conditions of such individuals, such as skin wrinkling, skin texture (e.g., elasticity and/or firmness), skin pigmentation (e.g., spots, tone, radiance, translucence, etc.), skin hydration, and the like; and (4) gather information from such individuals by verbal or written inquiry regarding age, UV exposure (e.g., frequency and duration of outdoor exposure and sunscreen habits), health habits (e.g., exercise habits, dietary habits, smoking/drinking habits, etc.), and the like.

Statistical methods well known in the art can then be used to define the correlation between the metabolic energy levels of skin cells from an individual and one or more or all of the above-described biological data. A suitable statistical method is a regression analysis is carried out to define such correlation. More preferably, a multivariate linear regression analysis is conducted to define correlation between the metabolic energy levels and the biological data as independent variables.

Specifically, an empirical study was conducted to take measurements of NADP(H) levels in granular cell samples collected from a sample group of 80 healthy Japanese females (n=80), using the two-photon tomographic technique. Further, the skin wrinkling, skin texture, skin pigmentation, and skin hydration of such individuals were measured using an APSII-100 Aramo portable scanner commercially available from Aram-Huvis (Korea). Various other skin measurement devices well known in the art can also be used to take the skin measurements.

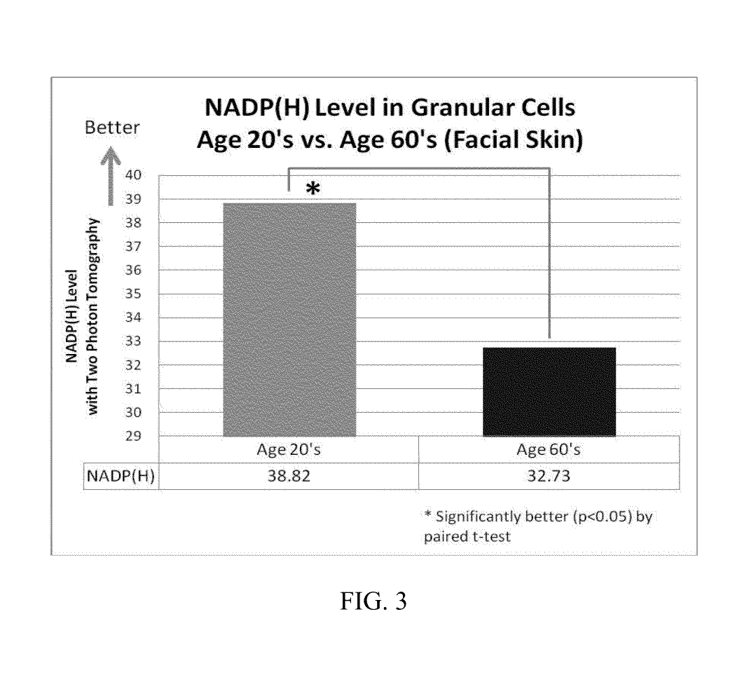

The measured NADP(H) levels in granular cell samples collected from a sample group were then correlated with their ages. Specifically, FIG. 3 is a graph showing two columns, one representing the average granular cell NADP(H) level in facial skin samples collected from individuals in their 20's, and the other representing the average granular cell NADP(H) level in facial skin samples collected from individuals in their 60's. The average granular cell NADP(H) level in facial skin samples collected from individuals in their 20's is about 38.82, while the average granular cell NADP(H) level in facial skin samples collected from individuals in their 60's is about 32.73. Therefore, it is clear that the average granular cell NADP(H) level in the skin cells of younger individuals is significantly higher than that of older individuals, with a statistical significance of p<0.05.

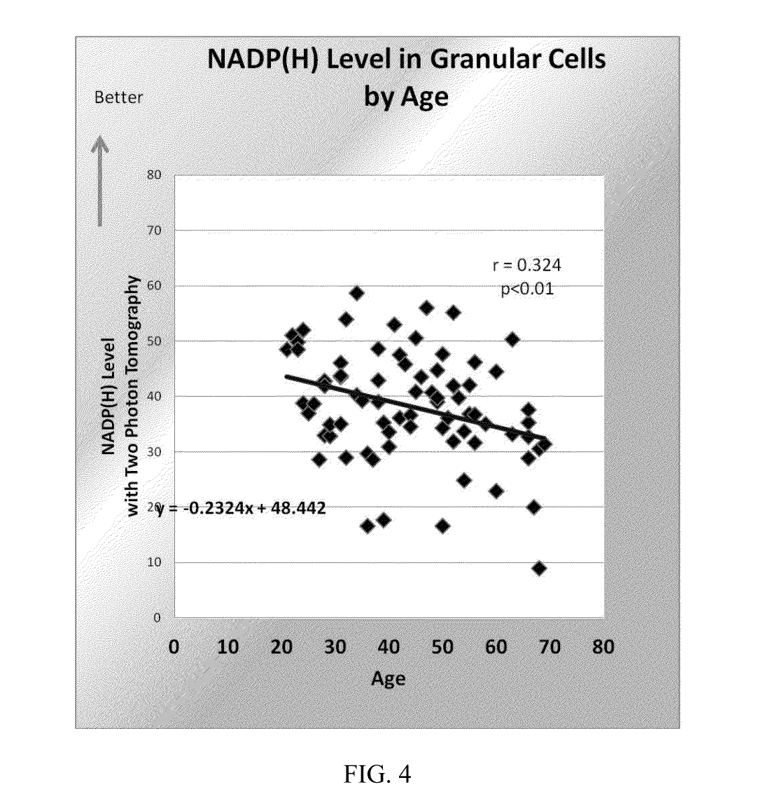

FIG. 4 is a graph plotting the measured granular cell NADP(H) levels against ages of the individuals. Specifically, a linear regression function of r=−0.234x+48.442 was formulated based on the observed correlation between the NADP(H) levels and the ages, as shown by the straight line in FIG. 4. This linear regression function can then be used to predict the NADP(H) level in the skin cells of an individual based on the age of such individual.

Such a linear regression function can be further expanded to include additional variants to form a linear multi-variant regression function. For example, additional biological information collected from the sample population of 80 healthy Japanese females, including the skin conditions such as skin wrinkling, skin texture (e.g., elasticity and/or firmness), skin pigmentation (e.g., spots, tone, radiance, translucence, etc.), skin hydration, and the like, and life-style choices such as UV exposure (e.g., frequency and duration of outdoor exposure and sunscreen habits), health habits (e.g., exercise habits, dietary habits, smoking/drinking habits, etc.), and the like, can be included to establish the multi-variant regression function, thereby achieving better prediction of NADP(H) levels.

### Biological Data Collection

The biological data, including the skin conditions and life-style choices of the individual, can be collected by any means known in the art, which are suitable for the practice of the present application. For example, the age and life-style choice information can be readily collected through a questionnaire or a survey, which can be in either paper form or electronic form and can be provided either on site or transmitted remotely (i.e., through telephone, facsimile, or internet). If the questionnaire or survey is in an electronic form, it can be filled out by the individual user either on site (i.e., at the cosmetic or skincare product sales counter) or remotely (i.e., at the individual user's office or home). The skin condition information can be collected by using either a hand-held device specifically designed to carry out certain skin measurements, such as the APSII-100 Aramo Portable Scanner, or a personal computer equipped with a digital camera for taking digital images of the individual user's skin and computer software for analyzing the skin conditions based on such digital images.

### Skin Energy Score Calculation

Once the function or correlation between the metabolic energy levels of skin cells from an individual and one or more of the biological data is established, a skin energy score can be correspondingly calculated as a parameter indicative of the skin metabolic energy of the individual.

For example, a scaled skin energy score of up to 100 can be calculated as the weighted sum of the individual's age, skin conditions, and life-style choices, while the weight allocated to each of these variables is determined by either the coefficient associated with it in the empirically established linear regression function described hereinabove, or the estimated impact it has on an individual's skin. Preferably, but not necessarily, the weights allocated to all of these biological data are determined by the coefficients associated with them in the empirically established multi-variant linear regression function described hereinabove.

In a specific embodiment of the present invention, a skin energy score (SK) of up to 100 is calculated according to the following function:

SK=A+B+C

wherein A is the weighted age-based prediction value for the granular cell NADP(H) level, B is the weighted life-style choice score, and C is the weighted skin condition score.

First, the weighted age-based predicted value for the granular cell NADP(H) level A is calculated as (−0.234×Age+48.442)×0.8297, which is derived from the empirically established linear regression function between age and granular cell NADP(H) as shown in FIG. 4 with the addition of a weight factor 0.8297. For an individual who is 35 years old, the weighted age-based predicted value for the granular cell NADP(H) level A is about 33.444.

The weighted life-style choice score B is calculated based on the following table:

TABLE 1
CALCULATION OF LIFE-STYLE CHOICE SCORE (B)

| Question | Answer | Scoring Criteria | Score |
|---|---|---|---|
| Outdoor time | 1-2 hrs | 1-2 hrs = 3 | 3 |
| on weekdays? | | 3-5 hrs = 2 | |
| | | 6-10 hrs = 1 | |
| Outdoor time on | 1-2 hrs | 1-2 hrs = 3 | 3 |
| weekends? | | 3-5 hrs = 2 | |
| | | 6-10 hrs = 1 | |
| Sunscreen usage? | Always | Always = 4 | 4 |
| | | Sometimes = 2 | |
| | | Never = 1 | |
| UV Exposure Score = | (Weekday outdoor score + | | 24 |
| | weekend outdoor score) × | | |
| | Sunscreen usage score | | |
| Smoking habit? | Never | Never = 4 | 4 |
| | | Sometimes = 2 | |
| | | Often = 1 | |
| Exercise habit? | 1-3 days | More than 3 days = 1 | 0.5 |
| | | 1-3 days = 0.5 | |
| | | Less than 1 day = 0 | |
| Healthy diet? | Never | Always = 1 | 0 |
| | | Sometimes = 0.5 | |
| | | Never = 0 | |

| | | |
|---|---|---|
| Life-Style Choice | UV Exposure Score + Smoking | 28.5 |
| Total (B) = | Habit Score + Exercise Habit | |
| | Score + Healthy Diet Score | |

The weighted skin condition score C is calculated based on the following table:

TABLE 1
CALCULATION OF SKIN CONDITION SCORE (C)

| Parameter | Measurement by Device | Weight factor | Score |
|---|---|---|---|
| Skin Wrinkling | 60 × | 7.5/100 | 4.5 |
| Skin Texture | 75 | | 5.625 |
| Skin Pigmentation | 76 | | 5.7 |
| Skin Hydration | 55 | | 4.125 |

| | | |
|---|---|---|
| Skin Condition | Skin Wrinkling Score + | 19.95 |
| Total (C) = | Skin Texture Score + Skin | |
| | Pigmentation Score + | |
| | Skin Hydration Score | |

Therefore, for an individual with age, skin conditions, and life-style choices as described hereinabove, the calculated total skin energy score (SK) is the sum of A, B, and C, which is approximately 81.9.

### Over-the-Counter Data Collection and Skin Energy Score Display

The algorithm for calculating the skin energy score as described hereinabove can be implemented into a software program, thereby enabling computer-aided automatic calculation of the skin energy score. A computer-based system equipped with such a software program and one or more biological data collection devices, such as the APSII-100 Aramo Portable Scanner or a digital camera, can then be readily used at the sales counters of cosmetic and skincare products to conduct real-time, cost-effective analysis of the skin cellular metabolic energy of an individual customer.

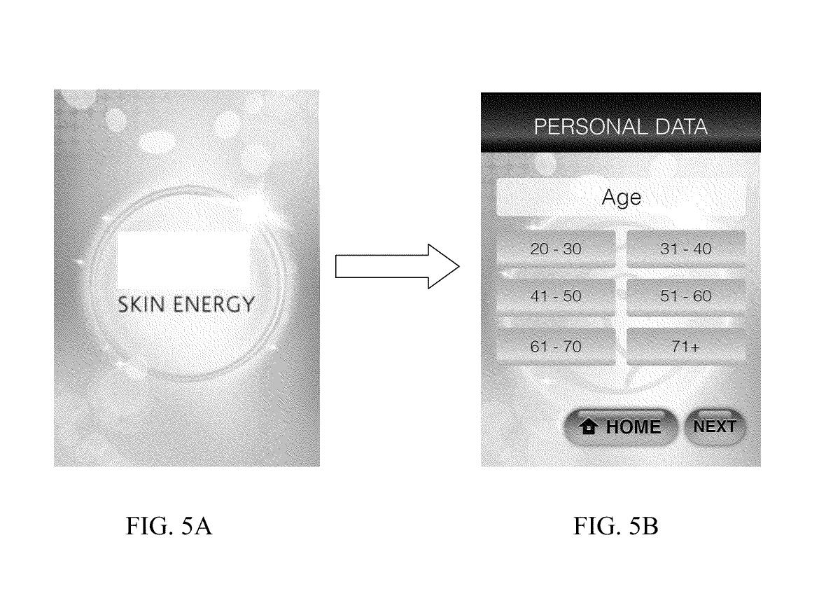

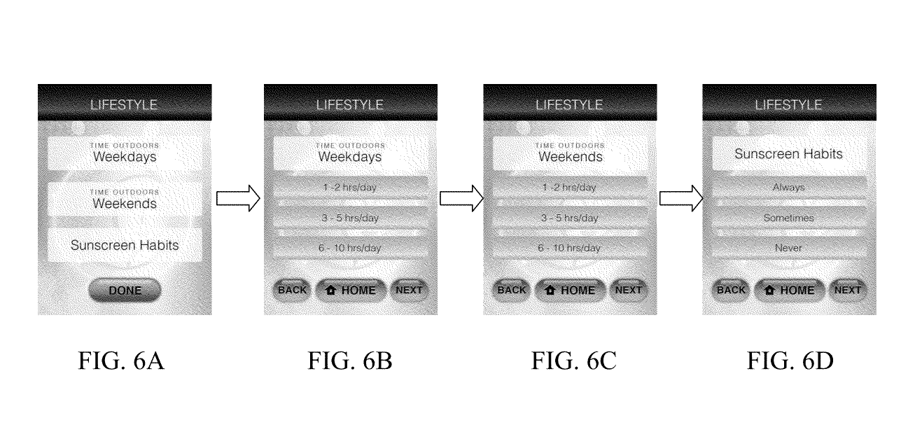

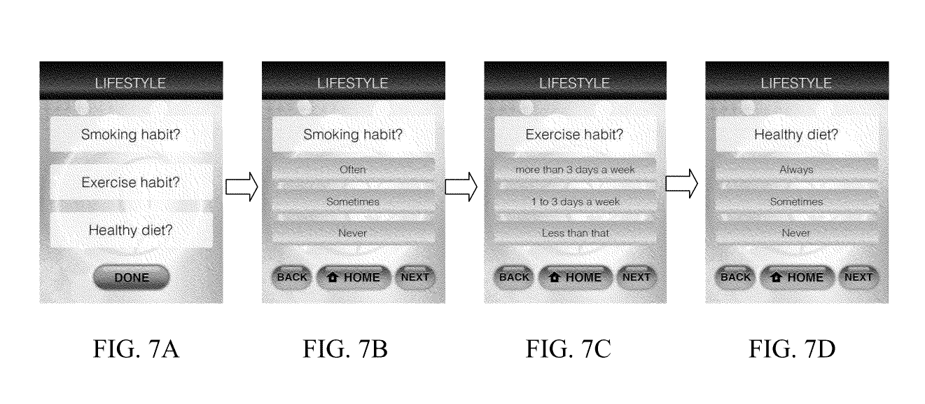

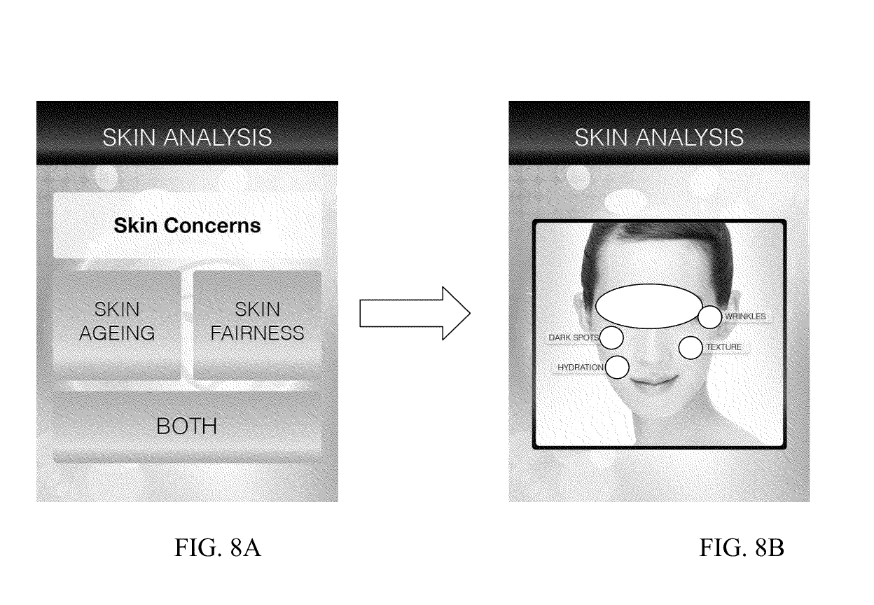

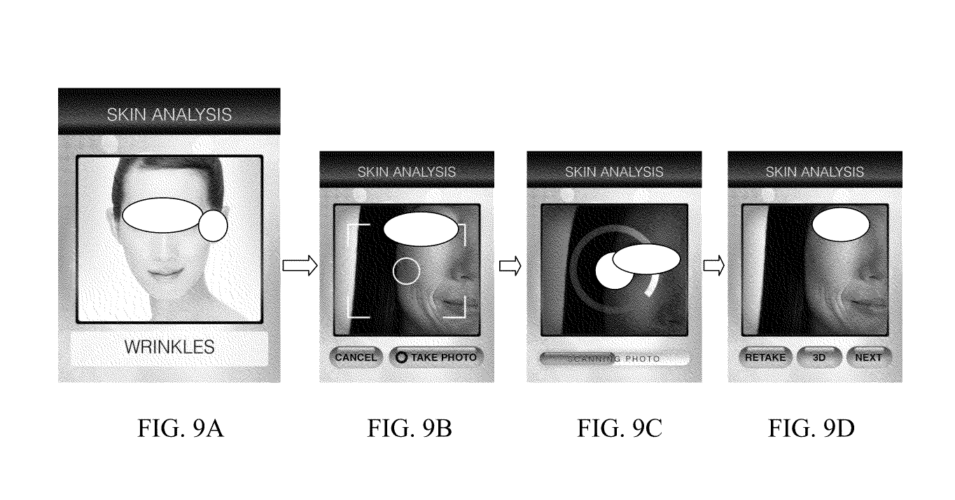

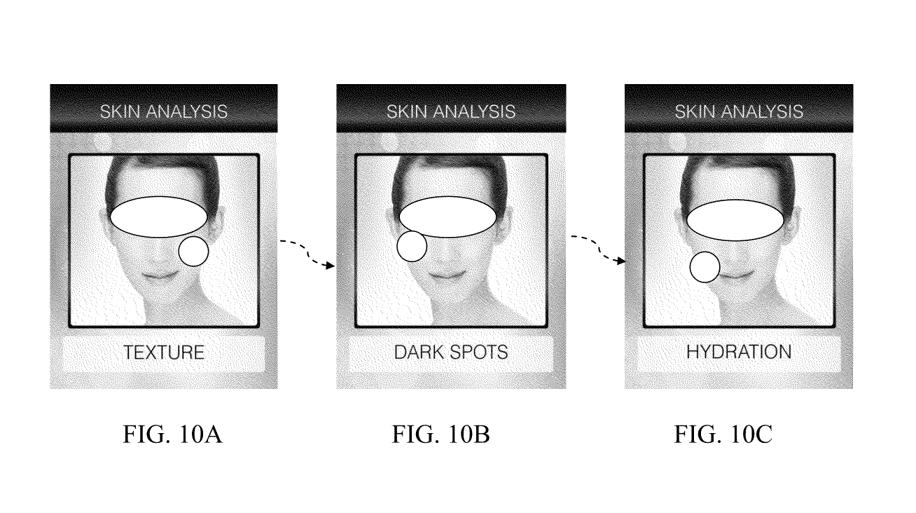

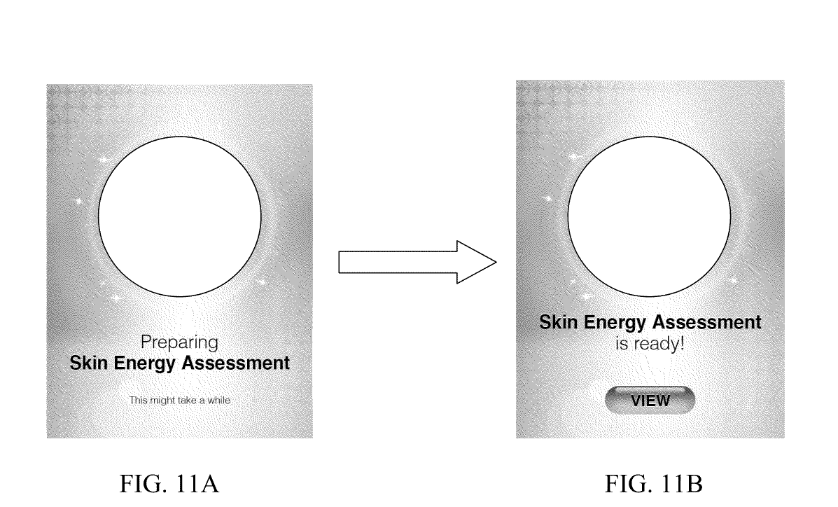

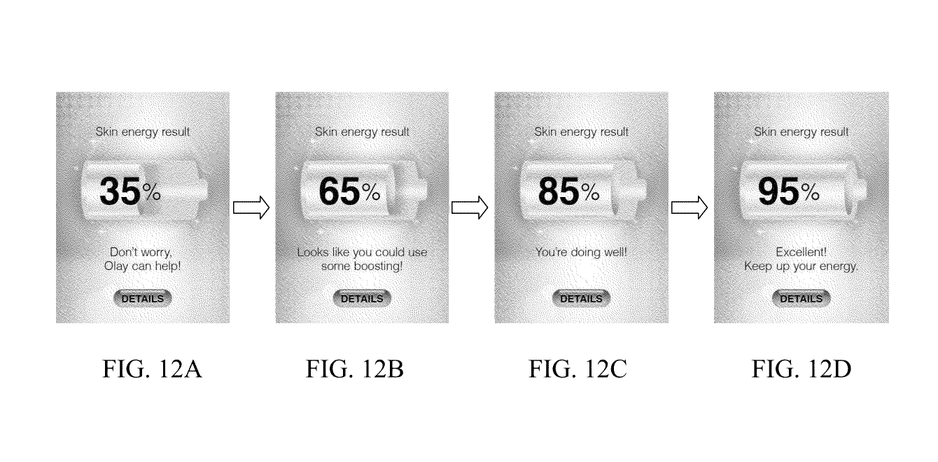

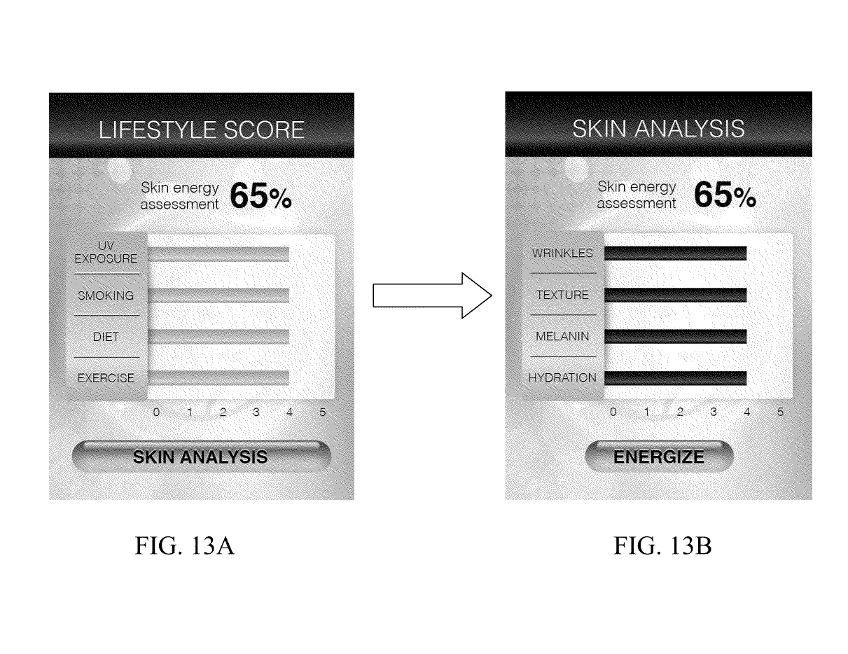

FIGS. 5A-13B are exemplary computer screenshots showing in detail the steps of collecting biological data from an individual and calculating/displaying the skin energy score computed based on such biological data indicative of the metabolic energy of the skin cells of such individual. Specifically, FIG. 5A shows the initial screenshot when the skin energy analysis program starts. FIG. 5B is the screenshot specifically designed for collecting the age information from the individual user. FIGS. 6A-6D are the screenshots designed for collecting the UV exposure data (i.e., outdoor duration during weekdays and weekends and sunscreen usage). FIGS. 7A-7D are the screenshots provided for collecting information related to the life-style choices of the individual user (i.e., smoking, exercise, and dietary habits). FIGS. 8A-10C are the screenshots provided for collecting information related to the skin conditions of the individual (i.e., skin wrinkling, texture, pigmentation, and hydration). Each of these skin condition parameters can be measured either by a hand-held electronic device such as APSII-100 Aramo Portable Scanner, or a digital camera, or any other devices suitable for capturing skin condition-related information. FIGS. 11A-13B are screenshots displaying the final skin energy score calculated together with corresponding suggestions or recommendations for next steps or treatments. In a preferred but not necessary embodiment of the present application, the system further provides recommendations of specific skincare or cosmetic products that the individual customer can use so as to improve their skin energy scores in the future.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for determining and displaying the metabolic energy of skin cells, comprising:
(a) one or more portable devices for collecting a set of biological data from an individual, wherein said set of biological data is selected from the group consisting of skin wrinkling, skin texture, skin pigmentation, skin hydration, age, UV exposure, health habits, and combinations thereof in relation to said individual;
(b) one or more computational devices for computing a skin energy score indicative of the metabolic energy of the skin cells of said individual, wherein said skin energy score is computed as a function of said one or more biological data, wherein said function is established by:
(1) collecting said one or more biological data and skin cell samples from a sample population of individuals;
(2) measuring the metabolic energy of the collected skin cell samples by detecting the concentration and/or distribution of one or more biomarkers; and
(3) correlating the measured metabolic energy of the skin cell samples with said one or more biological data collected from said sample population of individuals by a statistical method; and
(c) one or more output display devices for displaying the computed skin energy score on in-store sales counters.

2. The system of claim 1, wherein said one or more output display devices further provide recommendations of skin care products for the individual based on the computed skin energy score.

3. The system of claim 1, wherein said one or more portable devices are selected from the group consisting of hand-held electronic devices, personal computers, paper or electronic questionnaires, and combinations thereof.

4. The system of claim 1, wherein said one or more portable devices include a hand-held electronic device for measuring one or more of the skin wrinkling, skin texture, skin pigmentation, and skin hydration of said individual.

5. The system of claim 1, wherein said one or more portable devices include a personal computer or questionnaire for inquiring the age, UV exposure, and health habits.

6. The system of claim 1, wherein said health habits are selected from the group consisting of smoking habit, exercise habit, and dietary habit.

7. The system of claim 1, wherein said one or more biomarkers are selected from the group consisting of NADP(H), flavines, elastin, collagen, melanin, protoprophyrin IX monomers, and combinations thereof.

8. The system of claim 1, wherein said one or more biomarkers is NADP(H).

9. The system of claim 1, wherein the concentration and/or distribution of one or more biomarkers is detected by in vivo two-photon tomography.

10. The system of claim 1, wherein said statistical method is a regression analysis.

11. The system of claim 1, wherein said statistical method is a multivariate linear regression analysis.

12. The system of claim 1, wherein said computed skin energy score is a function of all biological data in said set collected from said individual.

13. The system of claim 1, wherein said set of biological data collected from said individual comprises the age of said individual.

14. The system of claim 1, wherein said set of biological data collected from said individual comprises skin wrinkling, skin texture, skin pigmentation, skin hydration, age, UV exposure, and health habits of said individual.

15. A method for determining and displaying the metabolic energy of skin cells, comprising the steps of:
(a) collecting a set of biological data from an individual, wherein said set of biological data is selected from the group consisting of skin wrinkling, skin texture, skin pigmentation, skin hydration, age, UV exposure, health habits, and combinations thereof in relation to said individual;
(b) computing a skin energy score indicative of the metabolic energy of the skin cells of said individual, wherein said skin energy score is computed as a function of one or more biological data in said set collected from said individual, wherein said function is established by:
(1) collecting said one or more biological data and skin cell samples from a sample population of individuals;
(2) measuring the metabolic energy of the collected skin cell samples by detecting the concentration and/or distribution of one or more biomarkers; and
(3) correlating the measured metabolic energy of the skin cell samples with said one or more biological data collected from said sample population of individuals by a statistical method; and
(c) displaying the computed skin energy score on in-store sales counters.

16. The method of claim 15, further comprising the step of recommending one or more skin care products for the individual based on the computed skin energy score.
